(19) United States
(12) Patent Application Publication
(10) Pub. No.: US 2016/0191997 A1
(43) Pub. Date: Jun. 30, 2016

(54) METHOD AND AN ELECTRONIC DEVICE FOR BROWSING VIDEO CONTENT

(71) Applicant: SPOTIFY AB, Stockholm (SE)

(72) Inventor: Richard Eklund, Sundbyberg (SE)

(21) Appl. No.: 14/586,772

(22) Filed: Dec. 30, 2014

(51) Int. Cl. H04N 21/4402; H04N 21/482; H04N 21/462; H04N 21/2187; H04N 21/414; H04N 21/4143; H04N 21/439; H04N 21/432

(52) U.S. Cl. CPC H04N 21/440281; H04N 21/4396; H04N 21/482; H04N 21/4325; H04N 21/2187; H04N 21/4825; H04N 21/41407; H04N 21/4143; H04N 21/4622

(57) ABSTRACT

The present disclosure relates to streaming of video content, including a method of operating an electronic device for browsing video content displayed at a display of the electronic device. Several video tiles are displayed at the display and each video tile comprises video content associated with a respective video stream. While the video tiles are being displayed at the display and while the video content of said video tiles is being played at the display, the electronic device may receive a request, or instruction, to preview played video content of a selected video tile. In response to receiving this request, the selected video tile is resized from its original size to a larger size to provide an effect of a zooming-in of the displayed video tile. Furthermore, the bit rate and/or the frame rate of the played video content is/are increased to improve the resolution of the played video content.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present disclosure generally relates to the providing of media content, and more particularly the providing of video content. In particular, the embodiments of the present invention relate to methods of operating an electronic device and a corresponding electronic device for browsing video content displayed at a display of the electronic device.

### BACKGROUND

As computer technology has improved, the digital media industry has evolved greatly in recent years. Users are able to use electronic devices such as mobile communication devices (e.g., cellular telephones, smart phones, tablet computers, etc.) to consume music, video and other forms of media content. For instance, users can listen to audio content (e.g., music) and/or watch video content (e.g., movies, television (TV) broadcasts, etc.) on a variety of electronic devices.

At the same time, advances in network technology have increased the speed and reliability with which information can be transmitted over computer networks. It is therefore possible for users to stream media content over computer networks as needed, or on demand, rather than transmitting a complete file in physical media (such as CD or DVD, or downloading the entire file) before consuming the media content.

When consuming video, the locating of a particular video from a movie collection or the locating of a particular television (TV) channel from a collection of TV channels may be difficult. For example, it may be difficult to browse a multitude of available video content. This browsing of video content may therefore be time consuming and, hence, cumbersome to some users. In turn, this may be frustrating to some users, particularly at times when the user cannot devote all of his/her attention to making the selection or at times when he/she wants or needs to locate the particular video content quickly.

### SUMMARY

It is in view of the above considerations and others that the various embodiments disclosed herein have been made.

There is a need for an improved method of operating an electronic device and a corresponding electronic device that allow a user to rapidly or efficiently scan through, or browse, video content that is displayed at a display of the electronic device. Advantageously, the method and the corresponding electronic device should support a video streaming service, i.e. a service where the video content is streamed to the electronic device.

Accordingly, it is a general object of the embodiments of the present invention to allow for an improved browsing of video content that is displayed at a display of an electronic device.

This general object has been addressed by the appended independent claims. Advantageous embodiments are defined in the appended dependent claims.

According to a first aspect, a method of operating an electronic device for browsing video content displayed at a display of the electronic device is provided. The method according to the first aspect comprises: displaying a plurality of video tiles at the display, wherein each video tile comprises video content associated with a respective video stream; and playing the video content of at least a subset of said video tiles, wherein playing the video content of said subset of video tiles includes playing the video content at a reduced bit rate and/or at a reduced frame rate, and wherein playing the video content further includes disabling audio output associated with the played video content. While said plurality of video tiles are being displayed at the display and while the video content of said subset of video tiles is being played, the method further comprises: receiving a first request to preview played video content of a selected video tile; in response to receiving the first request, resizing the selected video tile from a first size to a larger second size to provide an effect of a zooming-in of the displayed video tile, and also increasing the bit rate and/or increasing the frame rate of the played video content of the selected video tile to improve the resolution of the played video content.

In some embodiments, the method comprises playing the video content of all video tiles. Playing the video content of all video tiles includes playing the video content at the reduced bit rate and/or the reduced frame rate. Also, playing the video content of all video tiles further includes disabling the audio output associated with the played video content.

In some embodiments, increasing the bit rate and/or increasing the frame rate of the played video content of the selected video tile is/are performed simultaneously, or essentially simultaneously, as resizing the selected video tile from the first size to the larger second size.

The method may further comprise, in response to receiving the first request, enabling audio output associated with the played video content of the selected video tile.

In preferred embodiments, receiving the first request comprises detecting a gesture. The gesture may e.g. comprise a hovering gesture over a display area of the display, said display area corresponding to the selected video tile.

In some embodiments, while the video content of the selected video tile is being played at the display, the method additionally comprises: receiving a second request to continue playing the video content of the selected video tile; and in response to receiving the second request, resizing the selected video tile from the second size to a larger third size and continuing to play the video content utilizing the larger third size. In response to receiving the second request, the method may additionally comprise: increasing the bit rate and/or increasing the frame rate of the played video content of the selected video tile to improve the resolution of the played video content. The third size may be a size which substantially corresponds to a full size of the display. In preferred embodiments, receiving the second request comprises detecting a gesture. For instance, this gesture may be a press gesture or a tap gesture within a display area of the display, said display area corresponding to the selected video tile.

In some embodiments, the displaying of the plurality of video tiles at the display comprises arranging the plurality of video tiles in an array such as a two-dimensional grid or a list. Furthermore, arranging the plurality of video tiles in the array such as the two-dimensional grid or the list may additionally comprise arranging the plurality of video tiles in said array in accordance with a user-defined sequence.

The earlier-mentioned video stream may correspond to a live video stream. Additionally, or alternatively, the video stream may correspond to a channel, such as a television channel or a video channel.

According to a second aspect, there is provided an electronic device which is configured to execute, or otherwise perform, the method of the first aspect. For example, an electronic device for browsing video content is provided. The video content can be displayed at a display of the electronic device. The electronic device comprises: a display, a processor, and a memory. The memory stores computer program code, which, when run in the processor causes the electronic device to: display a plurality of video tiles at the display, wherein each video tile is adapted to comprise video content associated with a respective video stream; and play the video content of at least a subset of said video tiles, wherein playing the video content of said subset of video tiles includes playing the video content at a reduced bit rate and/or at a reduced frame rate, and wherein playing the video content further includes disabling audio output associated with the played video content; while said plurality of video tiles are being displayed at the display and while the video content of said subset of video tiles is being played: receive a first request to preview played video content of a selected video tile; in response to receiving the first request, resize the selected video tile from a first size to a larger second size to provide an effect of a zooming-in of the displayed video tile, and also increase the bit rate and/or increase the frame rate of the played video content of the selected video tile to improve the resolution of the played video content.

In some embodiments, the memory stores computer program code, which, when run in the processor causes the electronic device to play the video content of all video tiles at the reduced bit rate and/or at the reduced frame rate, and further disable the audio output associated with the played video content.

In some embodiments, the memory stores computer program code, which, when run in the processor causes the electronic device to increase the bit rate and/or increase the frame rate of the played video content of the selected video tile simultaneously, or essentially simultaneously, as resizing the selected video tile from the first size to the larger second size.

In some embodiments, the memory stores computer program code, which, when run in the processor causes the electronic device to enable audio output associated with the played video content of the selected video tile in response to receiving the first request.

The earlier-mentioned receiving of the first request may comprise detecting a gesture. This gesture may be a hovering gesture over a display area of the display, said display area corresponding to the selected video tile.

In some embodiments, the memory stores computer program code, which, when run in the processor causes the electronic device to, while the video content of the selected video tile is being played at the display: receive a second request to continue playing the video content of the selected video tile; and in response to receiving the second request, resize the selected video tile from the second size to a larger third size and continue to play the video content utilizing the larger third size.

In some embodiments, the memory further stores computer program code, which, when run in the processor causes the electronic device to increase the bit rate and/or increase the frame rate of the played video content of the selected video tile to improve the resolution of the played video content in response to receiving the second request.

The above-mentioned third size may be a size which substantially corresponds to a full size of the display.

The earlier-mentioned receiving of the second request may comprise detecting a gesture. This gesture may be a press gesture or a tap gesture within a display area of the display, said display area corresponding to the selected video tile.

In some embodiments, the memory stores computer program code, which, when run in the processor causes the electronic device to arrange the plurality of video tiles in an array such as a two-dimensional grid or a list. In one embodiment, the memory additionally stores computer program code, which, when run in the processor causes the electronic device to arrange the plurality of video tiles in said array in accordance with a user-defined sequence.

The earlier-mentioned video stream may correspond to live video stream. Additionally, or alternatively, the video stream may correspond to a channel, such as a television channel or a video channel.

In advantageous embodiments, the display is a touch-sensitive display.

The electronic device may be a mobile communication device. For example, the mobile communication device may be a laptop computer, a tablet computer, a mobile telephone, a cellular telephone or a smart phone.

Alternatively, the electronic device may be a stationary computer.

According to a third aspect, a computer program is provided. The computer program comprises instructions which, when executed on at least one processor, cause the at least one processor to carry out the method according to the first aspect. A carrier containing the computer program may also be provided. The carrier may e.g. be one of an electronic signal, an optical signal, a radio signal, or computer readable storage medium.

Various embodiments described herein allow for an enhanced browsing of video content displayed at a display of an electronic device. Resizing a selected video tile to an enlarged size and increasing the bit rate and/or increasing the frame rate of the played video content of the selected video tile allow the user to preview a zoomed-in version of the selected video tile, wherein the played video content of the selected video tile furthermore comes with an improved resolution. This preview may facilitate for the user to locate his or her desired video content quicker and/or more efficiently. The user can thus scan through, or browse, a multitude of video tiles including respective video content to locate desired video content quicker and/or more efficiently.

### BRIEF DESCRIPTION OF THE FIGURES

These and other aspects, features and advantages will be apparent and elucidated from the following description of various embodiments, reference being made to the accompanying drawings, in which:

FIG. 1 illustrates a system for playback of video content, in accordance with an embodiment.

FIG. 2 illustrates an example of a playback of video content, in accordance with an embodiment.

FIGS. 3A-3D illustrate an example of a user interface which supports playback of video content in accordance with an embodiment.

FIG. 4 illustrates a flowchart of a method according to an embodiment.

FIG. 5 illustrates an example implementation of an embodiment of an electronic device shown in FIGS. 1-3.

FIG. 6 illustrates a carrier containing a computer program, in accordance with an embodiment.

### DETAILED DESCRIPTION

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements or method steps throughout the description.

As described earlier, some existing solutions for browsing video content displayed at a display of an electronic device may be inadequate. For example, existing solutions for browsing video content may be perceived as unnecessarily time-consuming or cumbersome by some users. In turn, this may be perceived as frustrating. Furthermore, this frustration may be even more prevalent in situations where the user wishes to browse a multitude of video content (e.g., videos, TV channels, and/or movie channels) quickly. Wishing to browse a multitude of video content is e.g. common when consuming streamed video content.

It is therefore a general object of embodiments described herein to allow for an improved browsing of video content.

To address this, in accordance with an embodiment, described herein are an electronic device (e.g., a tablet computer or a smart phone) as well as a method of operating the electronic device for browsing video content displayed at a display of the electronic device.

A plurality of video tiles is displayed (e.g., in an array such as a two-dimensional grid) at the display of the electronic device. Each video tile comprises video content associated with a respective video stream. The video streams may include recorded video streams, such as recorded movies or recorded TV channel broadcasts (e.g. TV shows or TV events). Alternatively, or additionally, video streams may include live video streams such as live TV channel broadcasts (e.g., TV shows or TV events).

Video content of at least a subset of said video tiles is played. The playing of the video content of the subset of video tiles includes playing the video content at a reduced bit rate and/or at a reduced frame rate. This may be important, though not necessary, in order to be able to playback video content associated with several video streams concurrently. Furthermore, the playing of the video content of the subset of video tiles includes disabling audio output associated with the played video content. A reason for disabling the audio content may be to avoid the noise that would otherwise appear when playing the video content associated with the several video streams concurrently.

While said plurality of video tiles are being displayed at the display and while the video content of said subset of video tiles is being played, a first request to preview the played video content of a selected video tile is received. In response to receiving this first request, the selected video tile is resized from its first size (i.e., its original size) to a larger second size (i.e., a preview size) to provide an effect of a zooming-in of the displayed video tile. Also, the bit rate and/or the frame rate of the played video content of the selected video tile is/are increased in order to improve the resolution of the played video content that is played in the video tile having the larger second size.

Resizing a selected video tile to an enlarged size and increasing the bit rate and/or increasing the frame rate of the played video content of the selected video tile allow the user to preview a zoomed-in version of the selected video tile, wherein the played video content of the selected video tile furthermore comes with an improved resolution. This preview may facilitate for the user to locate his or her desired video content quicker and/or more efficiently. The user can thus scan through, or browse, a multitude of video tiles including respective video content to locate desired video content quicker and/or more efficiently.

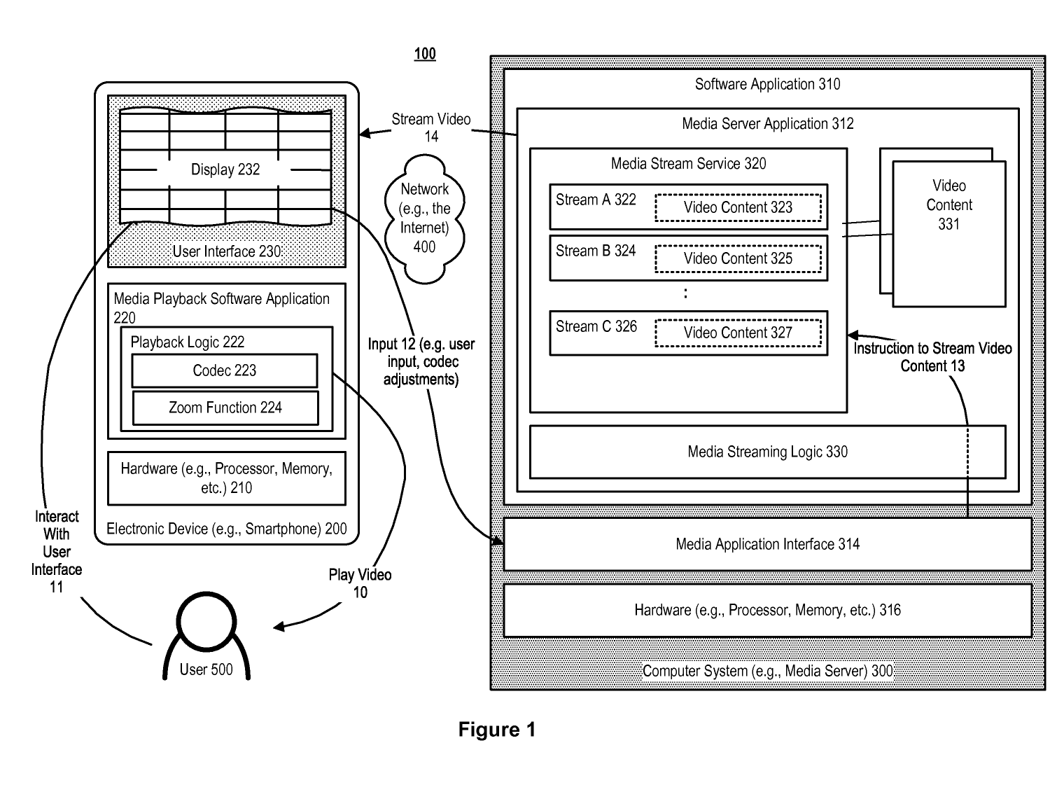

Turning now to the figures, various embodiments of the invention will be described in further detail. FIG. 1 illustrates a system 100 for playback of media content, in accordance with an example embodiment. The system 100 may comprise an electronic device 200 and a computer system 300 operating as a media server. The electronic device 200 may be communicatively connectable to the computer system 300 via a network 400, such as the Internet, as is conventional and known in the existing art. As can be seen in FIG. 1, only a single electronic device 200 and a single computer system 300 are shown. However, the computer system 300 may support the simultaneous use of multiple electronic devices, and/or the electronic device 200 can simultaneously access video content at multiple computer systems.

In the following description, the media content will be exemplified to be video content so as not to obscure the description of the embodiments disclosed herein with unnecessary detail. This should, however, not be interpreted as limiting the scope of the various embodiments of the invention.

As shown in FIG. 1, the electronic device 200 may be used for the playback of video content, which is provided by the computer system 300. The electronic device 200 may be a mobile telephone, such as a smart phone. Alternatively, the electronic device 200 may be a tablet computer. In yet other embodiments, the electronic device 200 may be any other electronic device capable of playback of video content such as, for example, one of the electronic devices of the following group: a computer, a laptop computer, and a mobile electronic device (e.g. a handheld entertainment device, a digital media player, or other media device).

The electronic device 200 may include one or several physical computer resources, or hardware resources 210. Likewise, the computer system 300 operating as a media server may include one or several physical computer resources, or hardware resources 316.

The computer system 300 may include an operating system or other processing system which supports execution of a software application 310, including a media server application 312 which may be used, for example, to stream video content. A media stream service 320 may be used to buffer video content 323, 325, 327, for streaming to one or more video streams 322, 324, 326. A media application interface 314 may receive requests from electronic devices 200 or other systems, to retrieve video content 331 from the computer system 300.

Video content or items 331 may be provided, for example, within a database or repository, or may be received by the computer system 300 from another source (not shown). This another source (not shown) may be external to the computer system 300, i.e. it may be located remotely from the computer system 300.

A media streaming logic 330 may be used to retrieve or otherwise access the video content 331 in response to requests from electronic devices 200 or other systems, and populate the video stream service with streams 322, 324, 326 of corresponding video content 323, 325, 327 that may be returned to the requesting electronic device 200.

In some embodiments, the electronic device 200 comprises a user interface 230. Typically, the user interface 230 includes a display 232, which is adapted to display or otherwise provide a visual array of video options, for example as a two-dimensional grid, a list, or other visual array format. The display 232 is preferably, though not necessarily, a touch-sensitive display that is adapted to detect or otherwise determine a user input. Each video option in the visual array of video options correspond to a respective video stream 322, 324, 326. Examples of visual arrays will be described in further detail below.

Selecting a particular video option within the visual array of the display 232 may be used, or otherwise interpreted, as a request or instruction to the media server application 312 to stream or otherwise return a corresponding particular item of video content. For example, in accordance with some embodiments, the software application 310 at the computer system 300 may be used to stream or otherwise communicate video content to the electronic device 200, wherein the display of said user interface 230 at the electronic device 200 is adapted to display a plurality of video options that correspond to respective video streams.

In accordance with some embodiments, the electronic device 200 may also include a media playback application 220, together with a playback logic 222, codec 223, and a zoom function 224, which may be used to control the playback of video content that is received from the media server application 312, for playback by the electronic device 200, as described in further detail below.

The codec 223 may be configured to adjust (e.g., increase or reduce) the bit rate and/or frame rate of a played video content. In other words, the codec 223 may be configured to adjust the quality of the played video content. The codec may communicate 12 such adjustments to the Media Application Interface 314 which, in turn, may communicate instructions 13 to the media stream service 320. In some embodiments, the codec 223 may be configured to detect or otherwise determine the available resources (e.g., bandwidth, processor capacity, memory capacity, battery power, etc.) of the electronic device 200 and adaptively adjust the quality of the played video content in dependence of the detected available resources.

The zoom-function 224 may be configured to resize (i.e., adjust the size) of a video tile between different sizes. For example, the zoom-function 224 may be configured to resize a video tile from one size to another, larger, size in order to provide an effect of a zooming-in of the displayed video tile. Also, the zoom-function 224 may be further configured to resize a video tile from one size to another, smaller, size in order to provide an effect of a zooming-out of the displayed video tile.

A user 500 may interact 11 with the user interface 230 and issue requests, for example the playing of a selected video content on the electronic device 200. The user's selection of a particular video option (or, stream) may be communicated 12 to the media server application 312, via the media application interface 314. The media server application 312 may then be instructed 13 to stream corresponding video content 13, including one or more streams of video content data 323, 325, 327, and subsequently stream 14 or otherwise communicate the, e.g., selected video, to the user's electronic device 200. In accordance with some embodiments, pre-buffering requests from the electronic device 200 may also be communicated to the media server application 312 via the media application interface 314. At the electronic device 200, in response to the user's interaction with the user interface 230, the media playback application 220, including the playback logic 222, may play 10 the requested video content to the user 500, for example by playing back a video on the electronic device 200, as described in further detail below.

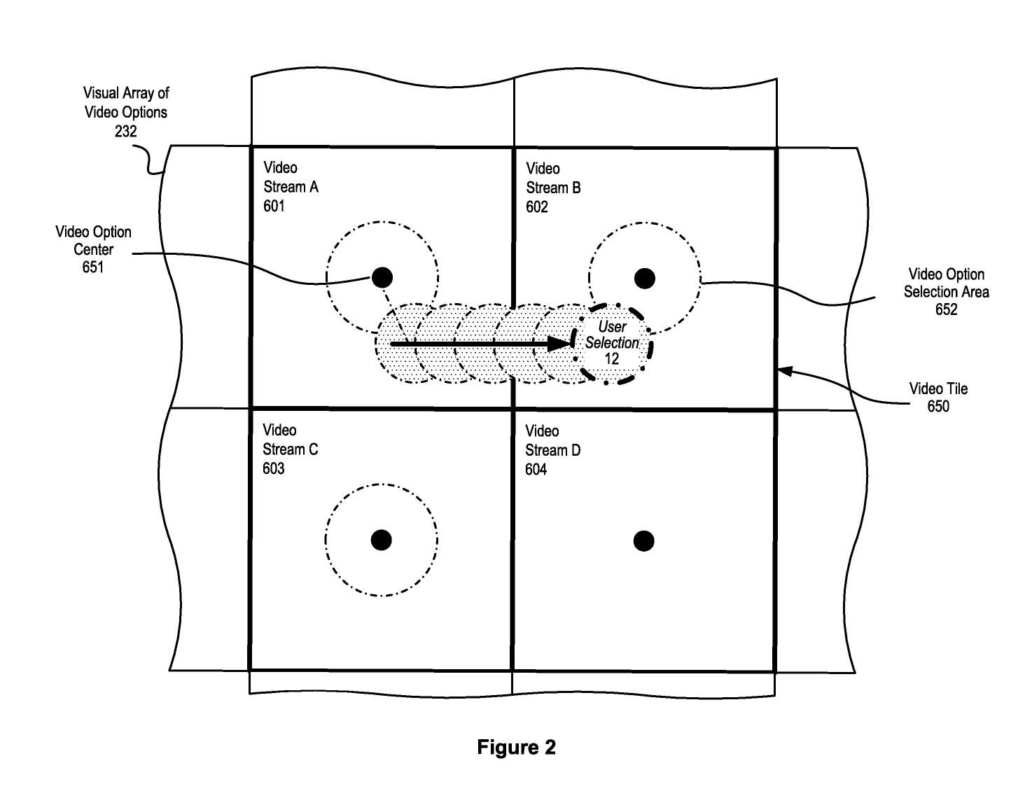

FIG. 2 illustrates an example of a visual appearance of a visual array of video options/streams that may be displayed at the display 232 of the electronic device 200 shown in FIG. 1. As illustrated in FIG. 2, in the example shown therein, four video streams A (601), B (602), C (603) and D (604) are visualized as video tiles 650. As used herein, a video tile 650 means a region of the display 232 that displays video content corresponding to a video stream 601, 602, 603, 604. Each video tile 650 has a respective video option center 651 (illustrated in the figure as a point) and a video selection area 652. Depending on the particular implementation, the video selection area 652 may be a comparatively smaller area compared with the whole area of the video tile 650. However, in some implementations the whole video tile area make up the video selection area 652, i.e. the video tile area equals the video selection area 652.

In accordance with an embodiment, a plurality of video tiles 650 can be displayed at the display 232. In other words, a plurality of video options/streams represented by corresponding video tiles 650 may be displayed, e.g. in a two-dimensional visual array, at the display 232. The plurality of video options may thus be displayed as an array of video tiles 650. Each video tile 650 comprises video content 323, 325, 327 associated with a respective video stream 322, 324, 326. For example, each video tile 650 may comprise streamed video content 323, 325, 327 of a respective video stream 322, 324, 326.

In accordance with an embodiment, a user 500 may provide input as a user selection 12 of a point or region, e.g. a video tile 650 of the plurality of video tiles. As described earlier, the user interface 230 includes a display 232. The display 232 may advantageously be a touch-sensitive display, which recognizes input in the form of a touch, for example the position of a user's finger (or a stylus) upon the display 232, to determine the selected point or region within the visual array of video tiles 650. Similarly, the display 232 may recognizes the selected point or region 12 as it is being moved, in response to a user input, within the visual array of video tiles. Although a touch-sensitive user display is described as particularly advantageous, those skilled in the art will appreciate that other user interfaces are possible too. For example, in the case of a mouse-based interface, the input can be provided by a mouse-down event. Alternatively, the user interface could be a motion detection based interface. Motion detection based interfaces detects a motion of an object (e.g. movement of a user's hand) and converts the detected motion into input useable by the electronic device 200.

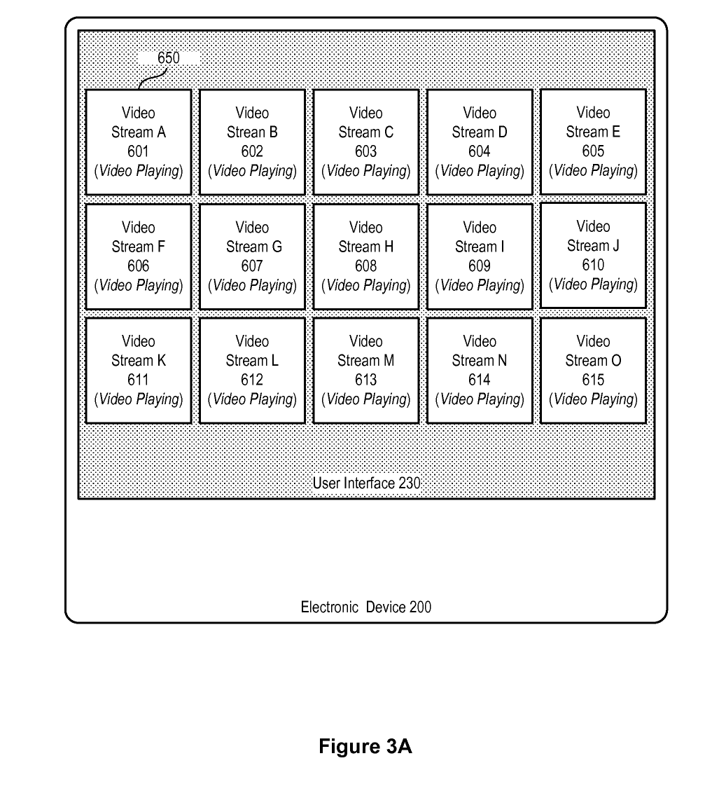

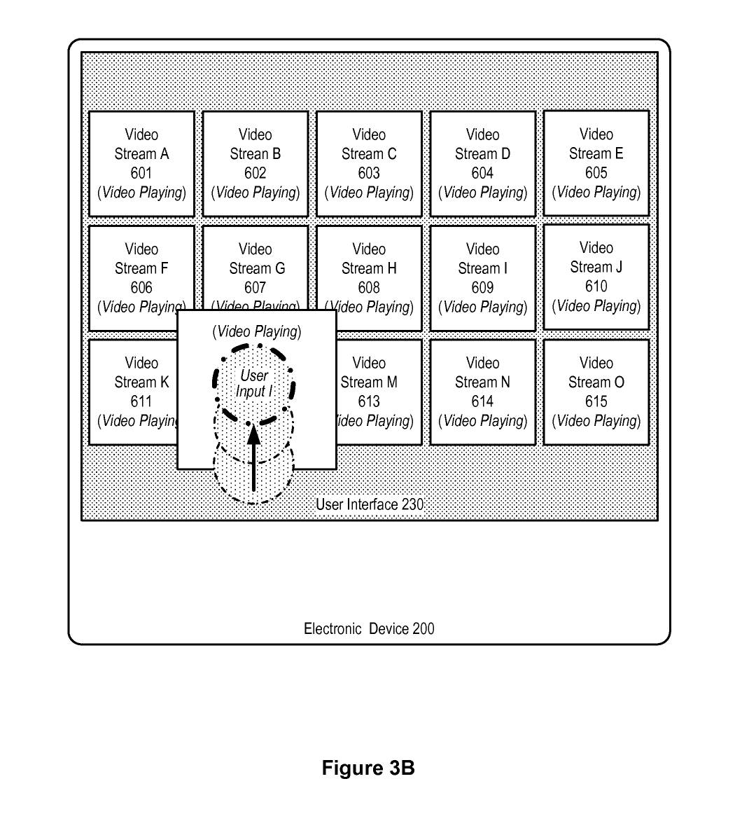

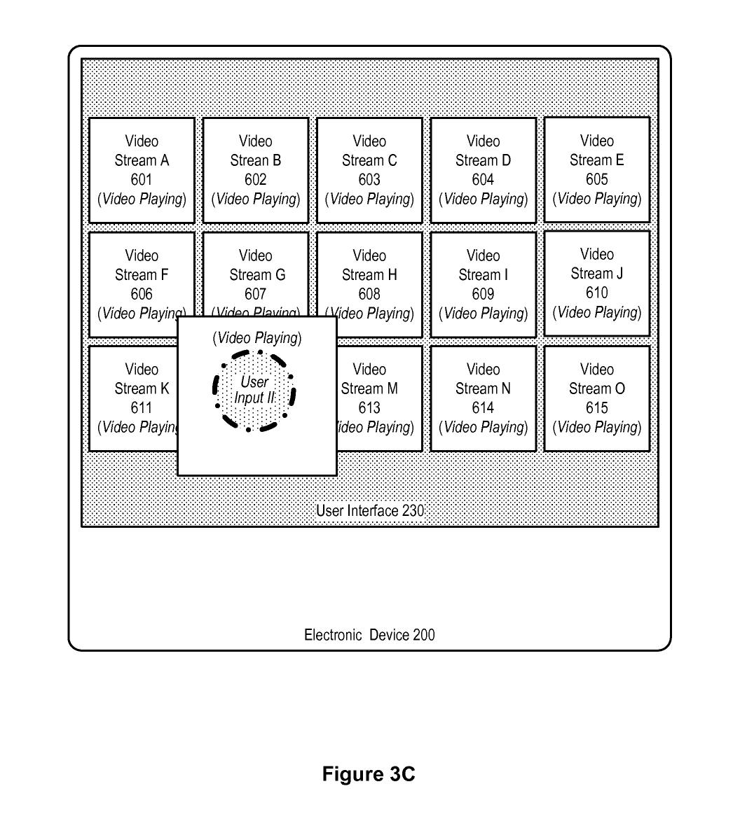

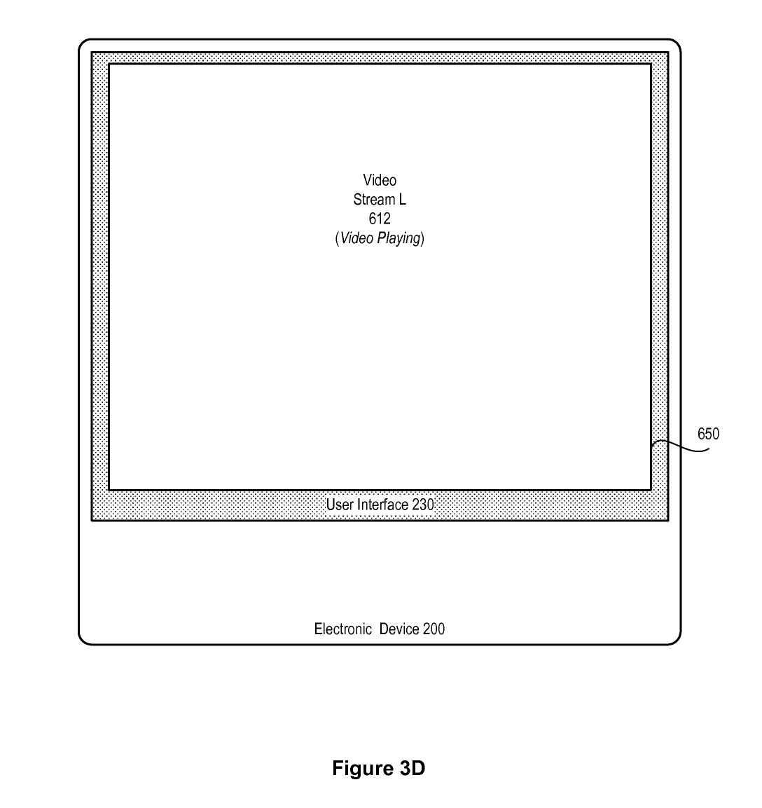

FIGS. 3A-3D illustrate an electronic device 200 with an exemplary user interface 230. In this example, the user interface 230 is a touch-sensitive user interface. As such, the user interface 230 comprises a touch-sensitive display. As will be appreciated, the user interface 230 supports playback of video content, in accordance with an embodiment.

As can be seen in FIG. 3A, a plurality of video tiles 650 is displayed at the display of the user interface 230. In this example, the plurality of video tiles 650 is advantageously arranged, or visualized, in a two-dimensional grid as shown in FIG. 3A. As will be appreciated, other arrangements or visualizations are however also possible. An example of a different array format is a list. A list may for example be arranged in a column or in a row. As will be appreciated by those skilled in the relevant art, the plurality of video tiles 650 may optionally be arranged in accordance with a user-defined sequence. In other words, the two-dimensional grid or the list mentioned hereinabove, may be arranged in a certain user-defined order.

Each video tile 650 comprises video content. The video content is associated with a respective video stream A (601), B (602), . . . , O (615). As described earlier, the video streams A-0 (601-615) may include recorded video streams, such as recorded movies or a recorded TV channel broadcasts (e.g. TV shows or TV events). Alternatively, or additionally, the video streams A-O (601-615) may include live video streams such as live TV channel broadcasts (e.g., TV shows or TV events).

In the example shown in FIG. 3A, the video content of all video tiles are played concurrently. While the user experience is generally improved by playing the video content of all video tiles concurrently, it is in fact not necessary that the video content of all video tiles is played concurrently. For example, in some embodiments only the video content of a subset of the video tiles is played concurrently. The exact number of video tiles in such subset may vary in different implementations. However, it is believed that the subset of video tiles should preferably represent a majority of video tiles from the total number of displayed video tiles 650.

As described above, the video content of all video tiles 650 is played concurrently. Advantageously, the video content of the video tiles 650 is played at a reduced bit rate and/or at a reduced frame rate. This may facilitate the playing of video content associated with many (or even very many) video streams A-O (601-615) concurrently. Furthermore, the audio output associated with the played video content is optionally disabled. This has the advantage that noise that would otherwise appear when playing the video content associated with the several video streams concurrently can be avoided.

Turning now to FIG. 3B, it can be seen that all video tiles 650 are being displayed at the user interface 230. Also, the video content associated with video streams A-O (601-615) is being played as described previously with reference to FIG. 3A. Upon a hovering gesture over a display area corresponding to a video tile including the video content associated with video stream L (612), the electronic device 200 receives a first request, or instruction, to preview the video content that is being played within the selected video tile. In response to receiving the first request, the electronic device 200 resizes, i.e. adjusts the size, the selected video tile from its first, original, size (see FIG. 3A) to a larger second size to provide an effect of a zooming-in of the displayed video tile. Furthermore, the electronic device 200 increases the bit rate of the played video content of the selected video tile to improve the resolution of the played video content associated with video stream L (612). Additionally, or alternatively, the electronic device 200 increases the frame rate of the played video content of the selected video tile to improve the resolution of the played video content associated with video stream L (612). In some embodiments, the increasing of the bit rate and/or increasing the frame rate of the played video content of the selected video tile can be performed simultaneously, or essentially simultaneously, as the resizing of the selected video tile from the first size to the larger second size. Furthermore, in response to receiving the first request, the electronic device 200 may optionally also enable (i.e., activate) the audio output associated with the played video content associated with the video stream L (612) being played in the selected video tile.

Resizing the selected video tile (i.e. the video tile over which the hovering gesture is detected by the user interface 230) to an enlarged size and increasing the bit rate and/or increasing the frame rate of the played video content of the selected video tile allow the user to preview a zoomed-in version of the selected video tile, wherein the played video content of the selected video tile furthermore comes with an improved resolution. This preview may facilitate for the user to locate his or her desired video content quicker and/or more efficiently. The user can thus scan through, or browse, a multitude of video tiles 650 including respective video content to locate desired video content quicker and/or more efficiently.

Reference is now made to FIG. 3C. Upon a press gesture, or a tap gesture, within a display area corresponding to the earlier-mentioned selected video tile, the electronic device 200 receives a second request, or instruction, to continue playing the video content associated with video stream L (612) of the selected video tile. In response to receiving the second request, the electronic device 200 resizes the selected video tile from the second size (see FIG. 3C) to a larger third size (see FIG. 3D) and continues to play the video content utilizing the larger third size shown in FIG. 3D. As will be appreciated, in response to receiving the second request the electronic device 200 may optionally also increase the bit rate and/or increase the frame rate of the played video content of the selected video tile even further to improve the resolution of the played video content associated with video stream L (612). The above-mentioned third size (see FIG. 3D) is advantageously, but not necessarily, a size which substantially corresponds to a full size of the display.

As will be appreciated by those skilled in the art, it is possible to return from the view illustrated in FIG. 3D to any of the views illustrated in FIGS. 3A-3D by interacting with the user interface 230 of the electronic device 200. As one mere example, a double-press gesture or a double-tap gesture within the display area corresponding to the video tile 650 displayed in FIG. 3D could be interpreted, or recognized, by the electronic device 200 as a third request, or instruction, to return to the view illustrated in FIG. 3A.

### Example Methods

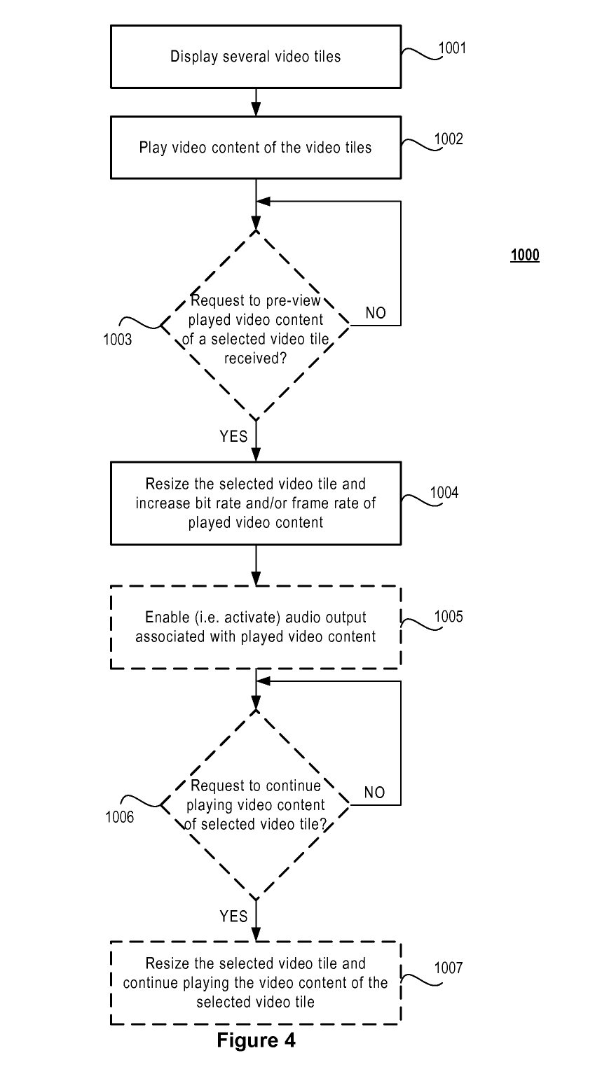

FIG. 4 illustrates an example method 1000 of operating an electric device 200 for browsing video content displayed at a display 232 of the electronic device 200.

The method 1000 comprises displaying 1001 a plurality of video tiles at the display. Each video tile comprises video content associated with a respective video stream, see FIGS. 3A-3D. Again, video streams may include recorded video streams, such as recorded movies or a recorded TV channel broadcasts (e.g. TV shows or TV events). Alternatively, or additionally, the video streams may include live video streams such as live TV channel broadcasts (e.g., TV shows or TV events). Displaying 1001 the plurality of video tiles at the display may e.g. comprise arranging the plurality of video tiles in an array such as a two-dimensional grid or a list. Furthermore, arranging the plurality of video tiles in the array such as the two-dimensional grid or the list may comprise arranging the plurality of video tiles in said array in accordance with a user-defined sequence.

The method 1000 also comprises playing 1002 the video content of all video tiles (or, at least a subset of said video tiles). Playing 1002 the video content of said video tiles advantageously includes playing the video content at a reduced bit rate and/or at a reduced frame rate. Also, playing 1002 the video content further includes disabling audio output associated with the played video content.

While said plurality of video tiles are being displayed 1001 at the display and while the video content of said video tiles is being played 1002, a first request to preview played video content of a selected video tile may be received. To this end, the method 1000 may include a step, or action, of checking 1003 whether a detection, or determination, of a first request to preview played video content of a selected video tile has been received, or otherwise occurred.

In response to receiving the first request, the selected video tile is resized 1004 from a first size to a larger second size to provide an effect of a zooming-in of the displayed video tile. Additionally, the bit rate and/or the frame rate of the played video content of the selected video tile is/are increased 1004 in order to improve the resolution of the played video content. In some embodiments, increasing 1004 the bit rate and/or increasing 1004 the frame rate of the played video content of the selected video tile may for example be performed simultaneously, or essentially simultaneously, as resizing 1004 the selected video tile from the first size to the larger second size.

Receiving the first request may comprise detecting a gesture, such as a hovering gesture over a display area of the display, wherein the display area corresponds to the selected video tile.

Optionally, audio output associated with the played video content of the selected video tile may also be enabled 1005, i.e. activated, such that a user may listen to the audio output associated with the played video content.

Furthermore, while the video content of the selected video tile is being played at the display, the method may additionally comprise the optional step, or action, of checking 1006 whether a detection, or determination, of a second request to continue playing the video content of the selected video tile has been received, or otherwise occurred.

In response to receiving a second request, the selected video tile is resized 1007 from the second size to a larger third size. Furthermore, the played video content continues to play utilizing the larger third size of the video tile. Advantageously, the bit rate and/or the frame rate of the played video content of the selected video tile is/are also increased upon resizing 1007 the video tile in order to improve the resolution of the played video content even further. As described earlier, the above-mentioned third size may for example be a size which substantially corresponds to a full size of the display.

Receiving the second request comprises detecting a gesture, such as a press gesture, or a tap gesture, within the display area corresponding to the selected video tile.

### Example Implementations of Embodiments of the Electronic Device

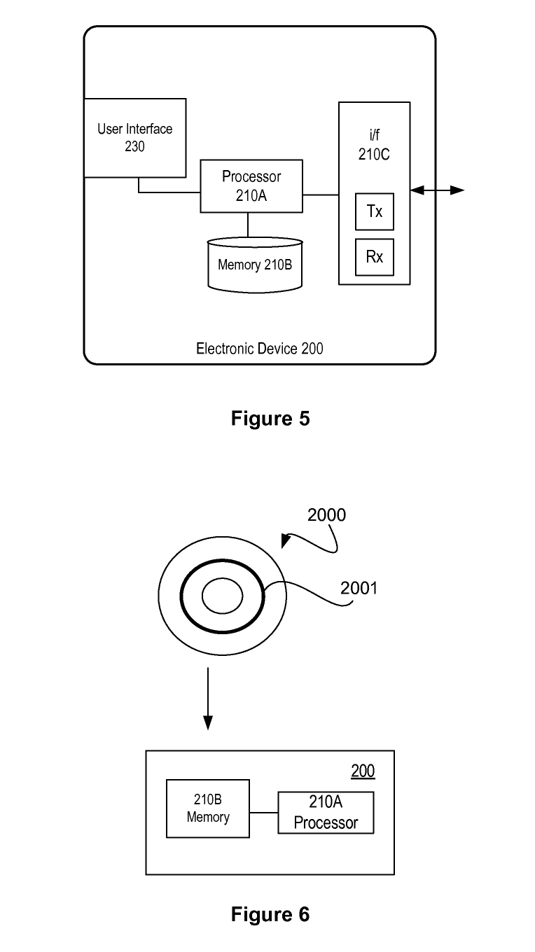

FIG. 5 illustrates an electronic device 200, which is suitable for browsing video content displayed at a display 232 of the electronic device 200. The electronic device 200 is advantageously, but not necessarily, a mobile communication device such as a laptop computer, a tablet computer, a mobile telephone, a cellular telephone or a smart phone. Alternatively, the electronic device 200 may be a stationary computer.

The electronic device 200 is configured to execute, or otherwise perform, the methods described throughout this disclosure.

As is schematically illustrated in FIG. 5, the electronic device 200 comprises hardware 210A-D. For example, the electronic device 200 may comprise one or more processors 210A and one or more memories 210B. Also, a communications interface 210C may be provided in order to allow the electronic device 200 to communicate with other electronic devices and/or servers 300, e.g. via a network 400 such as the Internet. To this end, the communications interface 210C may comprise a transmitter (Tx) and a receiver (Rx). Alternatively, the communications interface 210C may comprise a transceiver (Tx/Rx) combining both transmission and reception capabilities. The communications interface 210C may include a radio frequency (RF) interface allowing the electronic device 200 to communicate with other devices and/or servers 300 through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth®, etcetera. The electronic device 200 may further comprise a user interface 230, which may be comprised of a display and a keypad. Advantageously, the user interface including a touch-sensitive display. As such, the touch-sensitive display may be a touch screen display upon which virtual keys may be displayed and operated.

As described with reference to FIG. 1, the electronic device 200 may comprise one or more applications, e.g. the media playback application 220. The applications are sets of instructions (e.g., computer program code) that when executed by the one or more processors 210A controls the operation of the electronic device 200.

In some implementations, the one or more memories 210B stores computer program code, which, when run in the one or more processors 210A causes the electronic device 200 to display a plurality of video tiles at the display, wherein each video tile is adapted to comprise video content associated with a respective video stream; and to play the video content of at least a subset of said video tiles, wherein playing the video content of said subset of video tiles includes playing the video content at a reduced bit rate and/or at a reduced frame rate, and wherein playing the video content further includes disabling audio output associated with the played video content. Furthermore, the one or more memories 210B stores computer program code, which, when run in the one or more processors 210A causes the electronic device 200 to, while said plurality of video tiles are being displayed at the display and while the video content of said subset of video tiles is being played: receive a first request to preview played video content of a selected video tile; in response to receiving the first request, resize the selected video tile from a first size to a larger second size to provide an effect of a zooming-in of the displayed video tile, and also increase the bit rate and/or increase the frame rate of the played video content of the selected video tile to improve the resolution of the played video content.

In some embodiments, the one or more memories 210B stores computer program code, which, when run in the one or more processors 210A causes the electronic device 200 to play the video content of all video tiles at the reduced bit rate and/or at the reduced frame rate, and further disable the audio output associated with the played video content.

In some embodiments, the one or more memories 210B stores computer program code, which, when run in the one or more processors 210A causes the electronic device 200 to increase the bit rate and/or increase the frame rate of the played video content of the selected video tile simultaneously, or essentially simultaneously, as resizing the selected video tile from the first size to the larger second size.

In some embodiments, the one or more memories 210B stores computer program code, which, when run in the one or more processors 210A causes the electronic device 200 to enable audio output associated with the played video content of the selected video tile in response to receiving the first request.

For example, receiving the first request may comprise detecting a gesture. The gesture may comprise a hovering gesture over a display area of the display, said display area corresponding to the selected video tile.

In some embodiments, the one or more memories 210B stores computer program code, which, when run in the one or more processors 210A causes the electronic device 200 to, while the video content of the selected video tile is being played at the display: receive a second request to continue playing the video content of the selected video tile; and in response to receiving the second request, resize the selected video tile from the second size to a larger third size and continue to play the video content utilizing the larger third size.

In some embodiments, the one or more memories 210B stores computer program code, which, when run in the one or more processors 210A causes the electronic device 200 to increase the bit rate and/or increase the frame rate of the played video content of the selected video tile to improve the resolution of the played video content in response to receiving the second request. The third size may for instance be a size which substantially corresponds to a full size of the display.

Receiving the second request may comprise detecting a gesture. The gesture may comprise a press gesture or a tap gesture in a display area of the display, said display area corresponding to the selected video tile.

In some embodiments, the one or more memories 210B stores computer program code, which, when run in the one or more processors 210A causes the electronic device 200 to arrange the plurality of video tiles in an array such as a two-dimensional grid or a list. In one embodiment, the one or more memories 210B also stores computer program code, which, when run in the one or more processors 210A causes the electronic device 200 to arrange the plurality of video tiles in said array in accordance with a user-defined sequence.

Again, video streams may include recorded video streams, such as recorded movies or a recorded TV channel broadcasts (e.g. TV shows or TV events). Alternatively, or additionally, the video streams may include live video streams such as live TV channel broadcasts (e.g., TV shows or TV events).

### Example Computer-Readable Mediums

Turning now to FIG. 6, another embodiment will be briefly discussed. FIG. 6 shows an example of a computer-readable medium, in this example in the form of a data disc 200. In one embodiment the data disc 2000 is a magnetic data storage disc. The data disc 2000 is configured to carry instructions 2001 that can be loaded into a memory 210B of an electronic device 200. Upon execution of said instructions by a processor 210A of the electronic device 200, the electronic device 200 is caused to execute a method or procedure according to the embodiments disclosed in this disclosure. The data disc 2000 is arranged to be connected to or within and read by a reading device (not shown), for loading the instructions into the processor. One such example of a reading device in combination with one (or several) data disc(s) 2000 is a hard drive. It should be noted that the computer-readable medium can also be other mediums such as compact discs, digital video discs, flash memories or other memory technologies commonly used. In such an embodiment the data disc 2000 is one type of a tangible computer-readable medium. The instructions may alternatively be downloaded to a computer data reading device, such as a computer or other electronic device 200 capable of reading computer coded data on a computer-readable medium, by comprising the instructions in a computer-readable signal (not shown) which is transmitted via a wireless (or wired) interface (for example via the Internet) to the computer data reading device for loading the instructions into a processor 210A of the electronic device 200. In such an embodiment, the computer-readable signal is one type of a non-tangible computer-readable medium.

Various embodiments described herein allow for an enhanced browsing of video content displayed at a display of an electronic device. Resizing a selected video tile to an enlarged size and increasing the bit rate and/or increasing the frame rate of the played video content of the selected video tile allow the user to preview a zoomed-in version of the selected video tile, wherein the played video content of the selected video tile furthermore comes with an improved resolution. This preview may facilitate for the user to locate his or her desired video content quicker and/or more efficiently. The user can thus scan through, or browse, a multitude of video tiles including respective video content to locate desired video content quicker and/or more efficiently. Still further, the herein described embodiments allow for a browsing of video content that is user friendly and intuitive.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the described embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks, may be provided through the use of hardware such as circuit hardware and/or hardware capable of executing software in the form of coded instructions stored on the above-mentioned computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while certain gestures (e.g., hovering gestures, press gestures, and tap gestures) have been described to exemplify embodiments of the invention, other conceivable gestures also exist (e.g. flick gestures, swipe gestures, swipe-and-hold gestures, release-of-hold gestures) that could be contemplated when reducing embodiments of the invention into practice. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

What is claimed is:

1. A method of operating an electronic device for browsing video content displayed at a display of the electronic device, the method comprising:
displaying a plurality of video tiles at the display, wherein each video tile comprises video content associated with a respective video stream; and
playing the video content of at least a subset of said video tiles, wherein playing the video content of said subset of video tiles includes playing the video content at a reduced bit rate and/or at a reduced frame rate, and wherein playing the video content further includes disabling audio output associated with the played video content;
while said plurality of video tiles are being displayed at the display and while the video content of said subset of video tiles is being played:
receiving a first request to preview played video content of a selected video tile;
in response to receiving the first request, resizing the selected video tile from a first size to a larger second size to provide an effect of a zooming-in of the displayed video tile, and also increasing the bit rate and/or increasing the frame rate of the played video content of the selected video tile to improve the resolution of the played video content.

2. The method of claim 1, comprising:
playing the video content of all video tiles, wherein playing the video content of all video tiles includes playing the video content at the reduced bit rate and/or the reduced frame rate, and wherein playing the video content of all video tiles further includes disabling the audio output associated with the played video content.

3. The method of claim 1, wherein increasing the bit rate and/or increasing the frame rate of the played video content of the selected video tile is/are performed simultaneously, or substantially simultaneously, as resizing the selected video tile from the first size to the larger second size.

4. The method of claim 1, further comprising, in response to receiving the first request, enabling audio output associated with the played video content of the selected video tile.

5. The method of claim 1, wherein receiving the first request comprises detecting a gesture.

6. The method of claim 5, wherein the gesture comprises a hovering gesture over a display area of the display, said display area corresponding to the selected video tile.

7. The method of claim 1, further comprising, while the video content of the selected video tile is being played at the display:
receiving a second request to continue playing the video content of the selected video tile; and
in response to receiving the second request, resizing the selected video tile from the second size to a larger third size and continuing to play the video content utilizing the larger third size.

8. The method of claim 7, further comprising, in response to receiving the second request: increasing the bit rate and/or increasing the frame rate of the played video content of the selected video tile to improve the resolution of the played video content.

9. The method of claim 7, wherein the third size is a size which substantially corresponds to a full size of the display.

10. The method of claim 7, wherein receiving the second request comprises detecting a gesture.

11. The method of claim 10, wherein the gesture comprises a press gesture or a tap gesture within a display area of the display, said display area corresponding to the selected video tile.

12. The method of claim 1, wherein displaying the plurality of video tiles at the display comprises:
arranging the plurality of video tiles in an array such as a two-dimensional grid or a list.

13. The method of claim 12, wherein arranging the plurality of video tiles in the array such as the two-dimensional grid or the list further comprises:
arranging the plurality of video tiles in said array in accordance with a user-defined sequence.

14. The method of claim 1, wherein a video stream includes a live video stream.

15. The method of claim 1, wherein a video stream includes a recorded video stream.

16. An electronic device for browsing video content, which is displayable at a display of the electronic device, the electronic device comprising:
a display;
a processor; and
a memory storing computer program code, which, when run in the processor causes the electronic device to:
display a plurality of video tiles at the display, wherein each video tile is adapted to comprise video content associated with a respective video stream; and
play the video content of at least a subset of said video tiles, wherein playing the video content of said subset of video tiles includes playing the video content at a reduced bit rate and/or at a reduced frame rate, and wherein playing the video content further includes disabling audio output associated with the played video content;
while said plurality of video tiles are being displayed at the display and while the video content of said subset of video tiles is being played:
receive a first request to preview played video content of a selected video tile;
in response to receiving the first request, resize the selected video tile from a first size to a larger second size to provide an effect of a zooming-in of the displayed video tile, and also increase the bit rate and/or increase the frame rate of the played video content of the selected video tile to improve the resolution of the played video content.

17. The electronic device of claim 16, wherein the memory stores computer program code, which, when run in the processor causes the electronic device to play the video content of all video tiles at the reduced bit rate and/or at the reduced frame rate, and further disable the audio output associated with the played video content.

18. The electronic device of claim 16, wherein the memory stores computer program code, which, when run in the processor causes the electronic device to increase the bit rate and/or increase the frame rate of the played video content of the selected video tile simultaneously, or substantially simultaneously, as resizing the selected video tile from the first size to the larger second size.

19. The electronic device of claim 16, wherein the memory stores computer program code, which, when run in the processor causes the electronic device to enable audio output associated with the played video content of the selected video tile in response to receiving the first request.

20. The electronic device of claim 16, wherein receiving the first request comprises detecting a gesture.

21. The electronic device of claim 20, wherein the gesture comprises a hovering gesture over a display area of the display, said display area corresponding to the selected video tile.

22. The electronic device of claim 16, wherein the memory stores computer program code, which, when run in the processor causes the electronic device to, while the video content of the selected video tile is being played at the display:
receive a second request to continue playing the video content of the selected video tile; and
in response to receiving the second request, resize the selected video tile from the second size to a larger third size and continue to play the video content utilizing the larger third size.

23. The electronic device of claim 22, wherein the memory stores computer program code, which, when run in the processor causes the electronic device to increase the bit rate and/or increase the frame rate of the played video content of the selected video tile to improve the resolution of the played video content in response to receiving the second request.

24. The electronic device of claim 22, wherein the third size is a size which substantially corresponds to a full size of the display.

25. The electronic device of claim 22, wherein receiving the second request comprises detecting a gesture.

26. The electronic device of claim 25, wherein the gesture comprises a press gesture or a tap gesture in a display area of the display, said display area corresponding to the selected video tile.

27. The electronic device of claim 16, wherein the memory stores computer program code, which, when run in the processor causes the electronic device to arrange the plurality of video tiles in an array such as a two-dimensional grid or a list.

28. The electronic device of claim 27, wherein the memory stores computer program code, which, when run in the processor causes the electronic device to arrange the plurality of video tiles in said array in accordance with a user-defined sequence.

29. The electronic device of claim 16, wherein a video stream includes a live video stream.

30. The electronic device of claim 16, wherein a video stream includes a recorded video stream.

31. The electronic device of claim 16, wherein the display is a touch-sensitive display.

32. The electronic device of claim 16, wherein the electronic device is a mobile communication device.

33. The electronic device of claim 32, wherein the mobile communication device is a laptop computer, a tablet computer, a mobile telephone, a cellular telephone or a smart phone.

34. The electronic device of claim 16, wherein the electronic device is a stationary computer.
